(19) United States
(12) Patent Application Publication
(10) Pub. No.: US 2004/0076295 A1
(43) Pub. Date: Apr. 22, 2004

(54) Signal processing device and signal processing method

(76) Inventors: Tadashi Kojima, Yokohama-shi (JP); Hisashi Yamada, Yokohama-shi (JP); Taku Kato, Fuchu-shi (JP)

Correspondence Address: PILLSBURY WINTHROP, LLP, P.O. BOX 10500, MCLEAN, VA, 22102, US

(21) Appl. No.: 10/463,879

(22) Filed: Jun. 18, 2003

(30) Foreign Application Priority Data
Jun. 18, 2002 (JP) 2002-177375

(51) Int. Cl. H04N 7/167

(52) U.S. Cl. 380/201

(57) ABSTRACT

A signal processing apparatus comprises an error correction unit which adds an error correction signal to a digital signal and outputs an error correction block, a modulation unit which modulates the error correction block, a random signal generation unit which generates a random signal whose run length is limited, a changing unit which changes a part of the modulated error correction block to the random signal, and an output unit which outputs an output of the changing unit to a transmission medium or a recording medium.

### CROSS-REFERENCE TO RELATED APPLICATIONS

This application is based upon and claims the benefit of priority from the prior Japanese Patent Application No. 2002-177375, filed Jun. 18, 2002, the entire contents of which are incorporated herein by reference.

### BACKGROUND OF THE INVENTION

1. Field of the Invention

The present invention relates to a signal processing device and a signal processing method, for recording a digital signal in a recording medium, for transmitting a digital signal through a transmission medium, for reproducing a digital signal recorded in a recording medium, or receiving a digital signal transmitted from a transmission medium.

More specifically, the present invention relates to a recording or reproduction processing method for a recording medium which requires illegal copy protection processing from the viewpoint of copyright protection or the like.

2. Description of the Related Art

In recent years, with the progress of digital revolution, a variety of information is digitized, and is distributed through a transmission channel or a recording medium with a result that a very large number of people can obtain digital information freely. In such an environment, a digital signal such as video image, music or any other associated data which can be handled by a computer is recorded or reproduced in a recording medium, and information is reproduced from a reproduction only information medium, or is transmitted through a transmission channel, thereby carrying out information transmission or information storage.

For a storage medium, standardization for a DVD (a digital versatile disk) which is a recording medium capable of recording a large amount of digital data such as video image or music is achieved, so that one can enjoy a cinema lasting two hours or more at home freely. As a DVD, there exist media such as reproduction only DVD-ROM, a DVD-R capable of carrying out recording only one time, and a DVD-RW or DVD-RAM capable of freely carrying out recording and reproduction.

An applied DVD-ROM standard includes a DVD-video standard in which at least one cinema is completely recorded in one disk. By such DVD-video disk reproduction or reception of digital broadcasting, information through a digital signal can be obtained freely. In such an environment, the obtained digital signal is copied to a recording medium such as a hard disk or DVD-RAM, whereby a disk having recorded (copied) therein a digital signal identical to that contained in a source disk can be produced in large amount.

Because of this, digital information recorded in a DVD-video is encrypted. A copy protection method using encryption technique efficiently functions with a DVD-video disk or DVD-ROM disk having recorded therein information encrypted in advance.

In such information transmission processing or information storage processing, in recent years, handling of copyright protection has become important. In particular, in the case where information requiring copyright protection is recorded in a general recording medium, although a copyright owner permits information recording into only one recording medium, such an illegal action is considered that the same information is recorded in a plurality of recording media. Protection from such an illegal action is essential.

There is proposed in Jpn. Pat. Appln. KOKAI Publication No. 9-128890 a signal recording method and apparatus, a signal reproduction method and apparatus, a signal transmission method and apparatus, a signal receiving method and apparatus, and a recording medium capable of specifying whether a signal recorded in a recording medium or transmitted to a transmission medium is an original digital signal or a copied digital signal, and further, disabling reproduction or transmission when an illegal copy is conducted. In this proposal, a part of error correction code which is added to information data block is replaced with specific information. The specific information recorded in a partial region of the error correction code is extracted before error correction processing during recording or reproduction. An illegal copy or the like is protected by using the extracted specific information.

A reproduction apparatus samples predetermined partial data (specific information) before data after demodulated is processed to be corrected. With such a scheme, even if data after error correction is copied as a whole, specific information is lost by error correction processing. Thus, a copy in the same state as that in a source recording medium is disabled, and illegal copy processing can be protected.

Even by this proposal, however, if copy processing is conducted before an error check & correction processing, specific information is not lost, and thus, an illegal copy can be achieved. That is, the above described proposal cannot cope with a method for feeding modulation data before error check & correction processing to the recording apparatus, and then, recording the fed modulation data after being directly fed to a modulation unit without the addition of an error correction code.

As described above, in a conventional signal processing apparatus, there is no effective action against an illegal “batch copy” which records a decrypted signal in another medium at the demodulation apparatus.

### BRIEF SUMMARY OF THE INVENTION

According to an embodiment of the present invention, a signal processing apparatus comprises a first error correction unit which adds an error correction signal to a digital signal and outputs an error correction block, a modulation unit which modulates the error correction block, a random signal generation unit which generates a random signal whose run length is limited, a changing unit which changes a part of a modulated error correction block output from the modulation unit to the random signal, and an output unit which outputs an output of the changing unit to at least one of a transmission medium and a recording medium.

Additional embodiments and advantages of the present invention will be set forth in the description which follows, and in part will be obvious from the description, or may be learned by practice of the present invention.

The embodiments and advantages of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a view showing contents encryption of a copyright protection system;

FIG. 2 is a schematic view showing a DVD player for reproducing the encrypted contents shown in FIG. 1;

FIG. 3 is a schematic view showing a personal computer for reproducing the encrypted contents shown in FIG. 1;

FIG. 4 is a conceptual view showing a copyright protection system in a recording or reproduction apparatus;

FIG. 5 is a block diagram depicting a schematic configuration of the recording or reproduction apparatus;

FIG. 6 is a view showing a concept of illegal copy;

FIG. 7 is a view showing a structure of data in which specific information for protection from illegal copy is embedded;

FIG. 8 is a view showing a concept of illegal copy which can not be protected by the use of the data of FIG. 7;

FIG. 9 is a view showing a data structure for an error correction block in accordance with a DVD standard concerning an embodiment of the present invention;

FIG. 10 is a view showing a result obtained by row interleaving of the error correction block of FIG. 9;

FIG. 11 is a view showing a structure of one recording sector of FIG. 11;

FIG. 12 is a view showing a physical sector structure when the recording sector of FIG. 11 is recorded;

FIG. 13 is a view showing a modulation table for a modulator used in a DVD standard;

FIG. 14 is a view showing a principle of protection from illegal copy of specific information according to an aspect of the present embodiment;

FIG. 15 is a view showing a physical sector structure in which specific information has been embedded in one embodiment of the present invention;

FIG. 16 is an enlarged view of the physical sector in FIG. 15;

FIG. 17 is a block diagram depicting a specific information generating unit according to an aspect of the present embodiment;

FIG. 18 is a view showing data contained in a DSV control ROM of FIG. 17;

FIG. 19 is a view showing a format of specific information;

FIG. 20 is a view showing a detailed data structure of a physical sector according to the embodiment shown in FIG. 15;

FIG. 21 is a block diagram depicting a whole signal recording or reproduction system according to an aspect of the present embodiment; and

FIG. 22 is a block diagram depicting a whole signal recording or reproduction system according to another embodiment of the present invention.

### DETAILED DESCRIPTION OF THE INVENTION

Hereinafter, preferred embodiments of a modulation or demodulation device and method for signal recording reproduction or transmission according to the present invention will be described referring to the accompanying drawings.

Before describing the details of the embodiments, a description will be given with respect to a copyright protection system in a recording or reproduction apparatus which is considered as an improvement based on a copyright protection system CSS (Contents Scramble System) used in a DVD-video concerning a reproduction only DVD disk. This system is served as a transmission or reception system by the replacement of a recording medium with a transmission medium.

In a DVD-video, a digital signal such as a video image or audio is processed to be compressed in accordance with an MPEG scheme or the like. Further, a reproduction control signal or the like is added, and the added signal is formatted in the form of a digital data stream. This digital data is data-sectored into packet data in units of 2 Kbytes, and the sectored data is encrypted (data-scrambled). Then, an error correction code or synchronization signal and the like is added to be generated, and the added signal is recorded in a recording medium.

In a copyright protection system CCS, digital contents are encrypted in accordance with the CSS scheme when a disk is manufactured, and the encrypted digital contents are recorded in reproduction only media. Such a media reproduction process is reproduced by a general exclusive DVD player, but the encrypted contents are decrypted by a player's signal processor circuit. Then, compression data is decompressed by an MPEG decoder or the like, and a video/audio signal is reproduced. On the other hand, in reproduction processing in a computer environment such as a personal computer, digital data from media is reproduced by a DVD-ROM drive. The reproduced digital data first is, however, subjected to mutual authentication confirmed (bus confirmation) with an MPEG decoder module instead of being transmitted with it being loaded on a PC bus. Then, the encrypted contents are transmitted only to an authenticated decoder module.

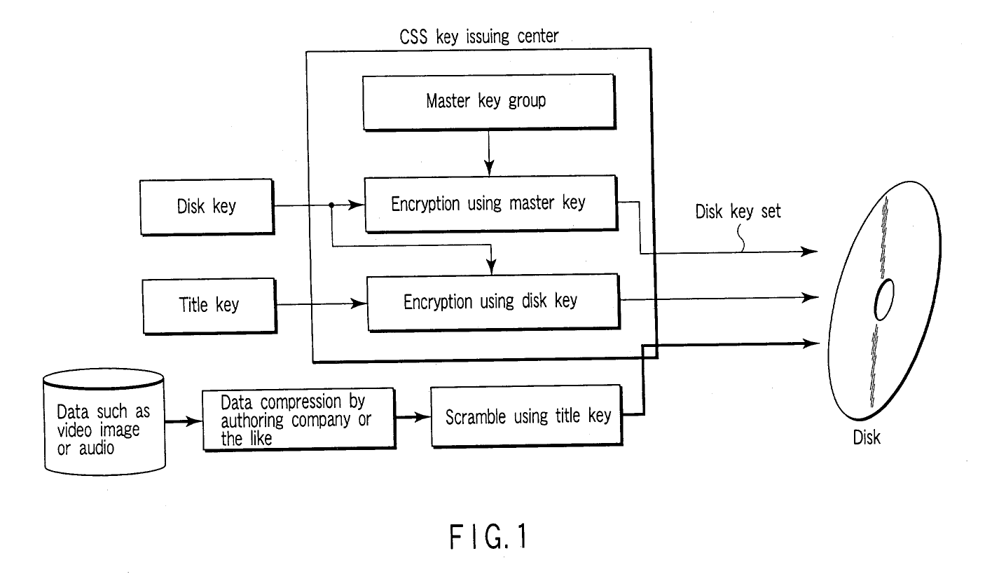

FIG. 1 is a schematic view showing contents encryption in the copyright protection system CSS scheme. Three types of encryption key data, namely, a master key group held by a DVDCCA (DVD Copy Protection Control Association) which is a CSS key issuing center of a CSS management mechanism; and a disk key (one for each disk) and a tile key (one for each tile) determined by a copyright owner, are hierarchically combined with each other, and digital data such as video image or music is encrypted. A master key is encryption key data which differs depending on manufacturers of a decryption LSI or software CSS module. The CSS management mechanism holds master keys of a number of manufacturers in all. When the disk key is encrypted, a disk key set is produced such that it can be basically decrypted by any master key, and the produced set is stored in a disk. By doing this, damage caused when information on master key provided to one manufacturer leaked can be reduced to the minimum. Specifically, during next disk key production and after, encryption is carried out while such a leaked master key is excluded. This makes it impossible to carry out decryption using the master key which has leaked once.

Recently, there is a CPPM (Contents Protection for Prerecorded Media) used for DVD-Audio or the like, and a device key DVK is used instead of a master key. A master key is provided on a manufacturer by manufacturer basis, whereas a device key DVK is provided on a device by device basis (on an individual set by set basis). A large number of encryption keys can be realized by the use of a combination of a plurality of keys for the device key DVK. Similarly, a scheme compatible with recording media includes a CPRM (Contents Protection for Recordable Media) scheme.

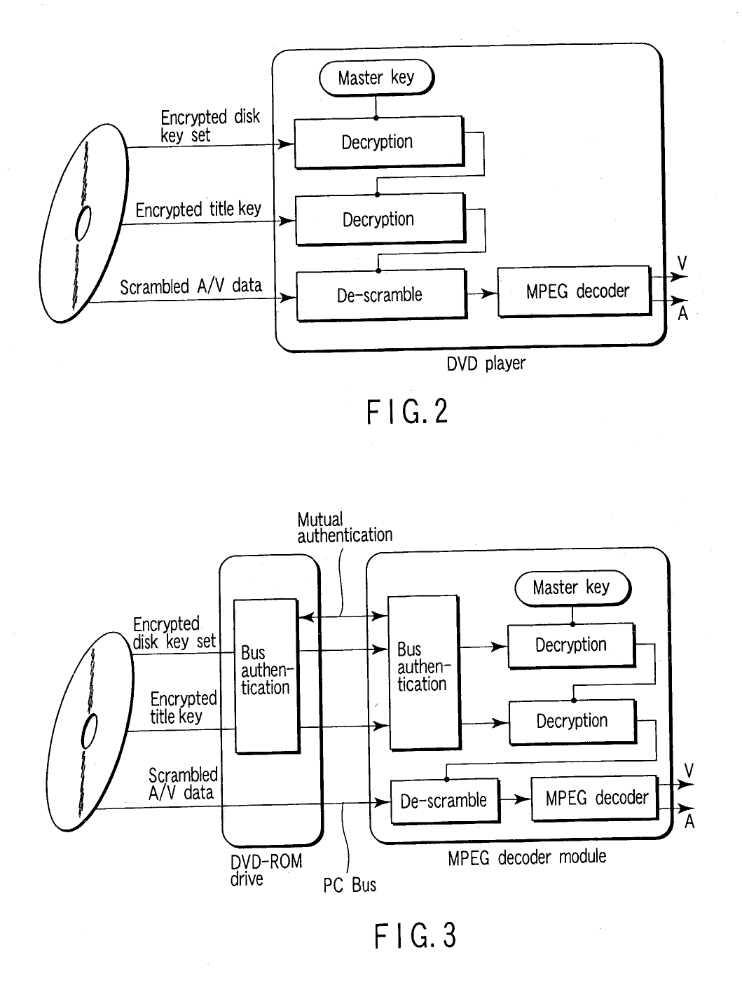

FIG. 2 is a schematic view showing a DVD player for reproducing a disk having recorded therein the encrypted contents produced in FIG. 1. An encrypted disk key set is read out from a disk, and a disk key is decrypted by a master key. Similarly, the encrypted title key read out from the disk is decrypted by the decrypted disk key, and scrambled A/V data which is encrypted contents is de-scrambled by the use of the decrypted title key. A video image signal V and an audio signal A are reproduced from the de-scrambled contents by an A/V decoder such as an MPEG decoder.

FIG. 3 is a schematic view showing bus authentication and contents decryption in a personal computer (PC) system. In a PC system, an encryption key and encrypted contents are recorded intact into another recording medium, thereby enabling copying, and copyright protection becomes invalid. Because of this, mutual authentication is carried out by a drive and an MPEG decoder module. Only in the case where a valid partner is authenticated, an encrypted disk key set and an encrypted title key are transmitted. As a result, an encryption key is obtained, the scrambled contents are de-scrambled, and original source data is obtained.

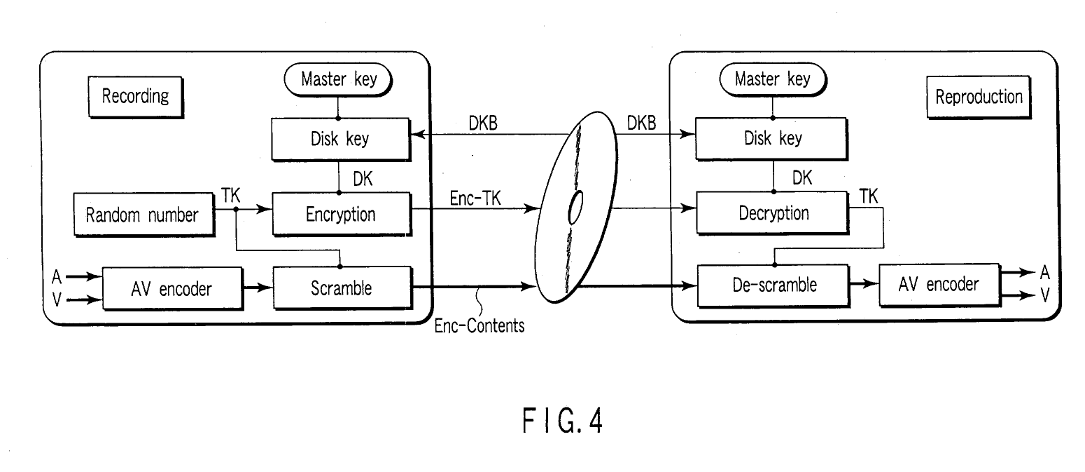

FIG. 4 shows a conceptual configuration of a copyright protection system in a recording or reproduction apparatus. Video/audio contents are scrambled (encrypted) using a title key TK generated by a random signal generator as an encryption key. The title key TK is encrypted by the disk key DK, and the encrypted title key Enc-TK is recorded in a disk. The disk key DK is a key obtained by reading out a disk key block DKB from a medium, and then, decrypting the read key by a master key MK in the same manner as that for a disk key in a reproduction only apparatus. In a disk, the disk key block DKB in which the disk key DK has been encrypted by many master keys MKs is recorded in advance. Then, the disk key DK is decrypted by a master key MK embedded in the recording or reproduction apparatus, and the obtained key is utilized as an encryption key for a tile key TK. At the reproduction apparatus, contents decryption is carried out in accordance with processing which is the same as that in FIG. 2.

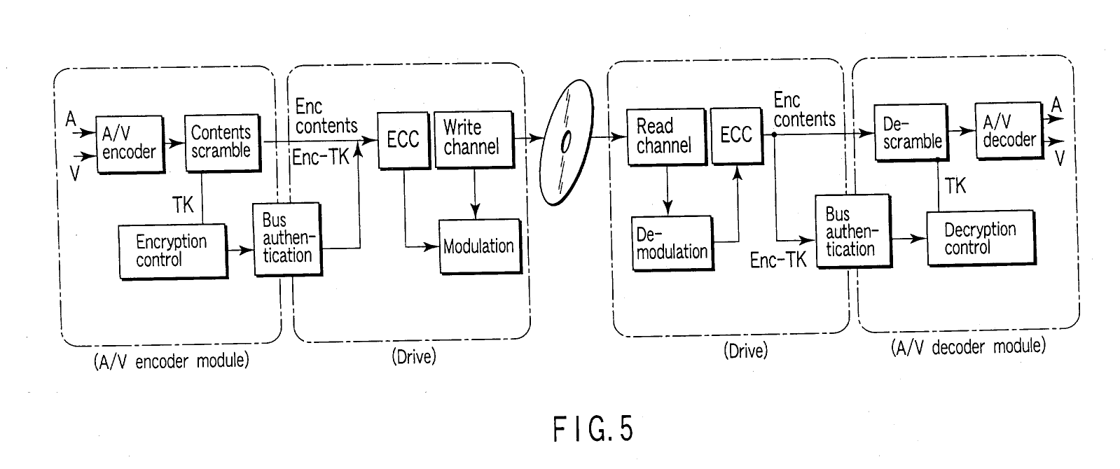

FIG. 5 is a block diagram depicting a schematic configuration of a recording or reproduction apparatus. In an exclusive recorder in a general commercially available equipment environment, an illegal copy is not expected so much. In a personal computer environment, however, it is possible to easily copy the data read out by a drive in another recording medium. In such a personal computer environment, a system is configured with a recording medium being a peripheral device. A drive shown in FIG. 5 generally carries out recording or reproducing operation irrespective of the contents of data. In order to protect a copyright, it is necessary to use bus authentication shown in FIG. 3 which is a reproduction only system. At the recording apparatus, the title key TK which is an encryption key is encrypted by a device key DK, and an encrypted title key Enc-TK is obtained. When the encrypted title key Enc-TK is transmitted to a recording drive, however, it is necessary to transmit it in accordance with bus authentication processing. As another process, a process generally similar to each process in CSS is carried out.

A copy protection method using the above described encryption technique efficiently functions in a DVD-video disk or DVD-ROM disk in which encryption data has been recorded in advance. In the case of a DVD-RAM or the like in which a user can newly record information, however, the following problems can occur.

(1) It is difficult to introduce a strong, inexpensive encryption device in a recording apparatus which a general user utilizes.

(2) Management of an encryption key is difficult.

(3) At the information recording apparatus, in the case where encryption or decryption is carried out, there is a high possibility that copying of information targeted for copy protection is easily carried out.

(4) By copying encrypted contents and encryption key as a whole, an illegal disk reproduced by a normal apparatus can be produced (in the case where a secret region is not present).

(5) In the case of handling an audio signal, that signal is handled on a basis of a number of files (music), and it is difficult to maintain copyright protection capability in response to a request for managing the audio signals on a file by file basis.

From the foregoing, in copy protection of a digital signal, it is difficult to cause the conventional encryption technique to efficiently function. In the case of reproducing encrypted recording information, decryption processing is applied in reproduction processing. Thus, depending on handling of a digital signal after decryption, the possibility of illegal copy still remains. In particular, by carrying out “batch copy” for information concerning encryption or an encryption key, there is a possibility that a large amount of duplicate recording media can be produced.

As in DVD, if there exist a variety of media such as a reproduction only DVD-ROM or recording or reproduction DVD-R/RW/RAM and the like, it becomes difficult to discriminate whether a digital signal recorded in a recording medium is a source original signal or an illegally copied digital signal. This problem occurs similarly in another recording medium.

Therefore, from the viewpoint of copyright protection, it is desirable to encrypt a digital signal such that only a correct system can decrypt the encrypted digital signal. In addition, it is desirable to confirm by the reproduction apparatus whether an input digital signal is an original digital signal or an illegally copied signal. If a part of a protection system is embedded in a region in which a general user can not access, the capability of copyright protection can be remarkably improved.

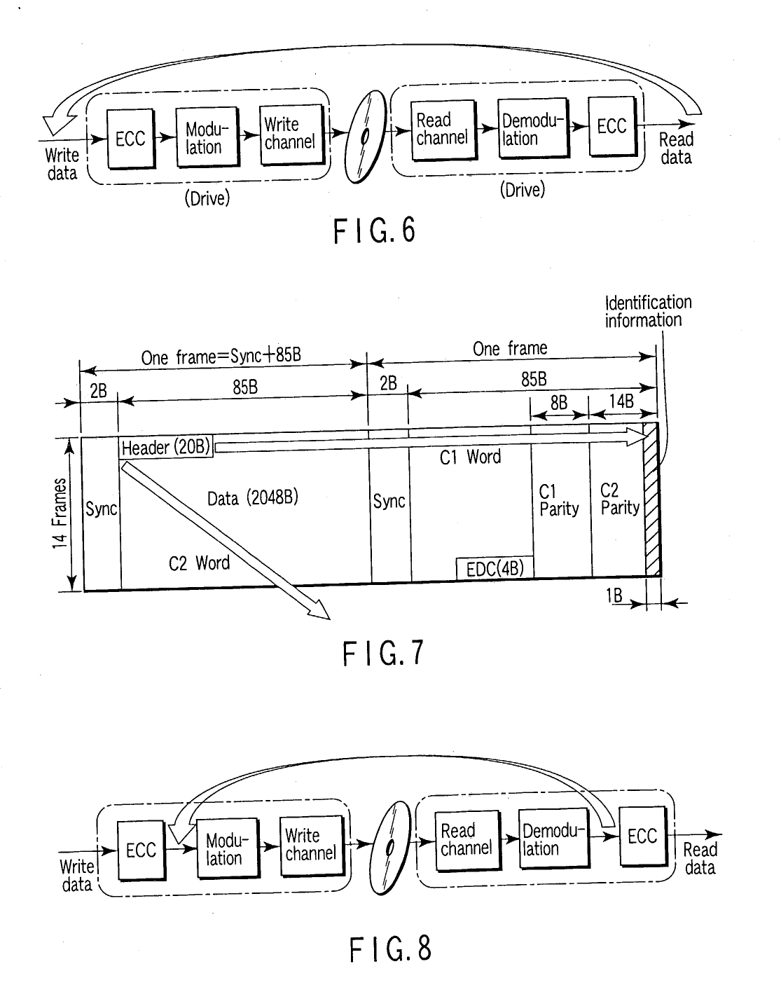

FIG. 6 illustrates an illegal copy route caused by a “batch copy.” In general, an object of a recording or reproduction drive used in a computer environment is to record/reproduce information in accordance with an instruction from a CPU. Thus, the contents recorded in media (such as contents of information or control code for information) are not determined, and thus, readout data is open. Therefore, all data read out by a reproduction drive is fed to a recording drive, and the fed back data is recorded in another recording medium in readout order, whereby a number of recording media having recorded therein the same information can be produced.

In order to prevent a “batch copy,” a part of error correction code which is added to information data block is replaced with specific information. The specific information recorded in a partial region of the error correction code is extracted before error correction processing during recording or reproduction. An illegal copy or the like is protected by using the extracted specific information.

FIG. 7 is a view for illustrating a state in which specific information which is identification information for protection from illegal copy or the like is replaced with a part of sector data. Error correction codes C1 (8 bytes) and C2 (14 bytes) are allocated to be added to sector data for 148 bytes×14 rows in a row direction, and an error correction block (sector data) for 170 bytes×14 rows to which the error correction codes have been added is configured. Here, a part of the error correction code C2 is replaced with specific information which is identification information for detecting an illegal copy. After such identification information has been added by such replacement, data in a data region, a correction code, and identification information are modulated. Each row composed of main data, correction codes, and identification information is divided into two frames on a 85 byte by 85 byte basis, and a 2-byte frame sync is added at the beginning of respective frames. After such signal processing, the processed data is recorded in a recording medium.

A reproduction apparatus samples predetermined partial data (specific information) before data after demodulated is processed to be corrected. With such a scheme, even if data after error correction is copied as a whole, specific information is lost by error correction processing. Thus, a copy in the same state as that in a source recording medium is disabled, and illegal copy processing can be protected.

Even by this proposal, however, if copy processing as shown in FIG. 8 is conducted, specific information is not lost, and thus, an illegal copy can be achieved. That is, the above described proposal cannot cope with a method for feeding modulation data before error correction processing to the recording apparatus, and then, recording the fed modulation data after being directly fed to a modulation unit without the addition of an error correction code.

The present invention aims to provide an effective action against an illegal “batch copy” which records a decrypted signal in another medium at the demodulation apparatus.

A basic structure of data required for describing a first embodiment in detail will be described using a DVD as an example.

Digital data is data sectored into packet data on a 2 Kbytes by 2 Kbytes basis, and the sectored digital data is blocked by an error correction code (ECC) for error correction processing on a 16 sectors by 15 sectors basis.

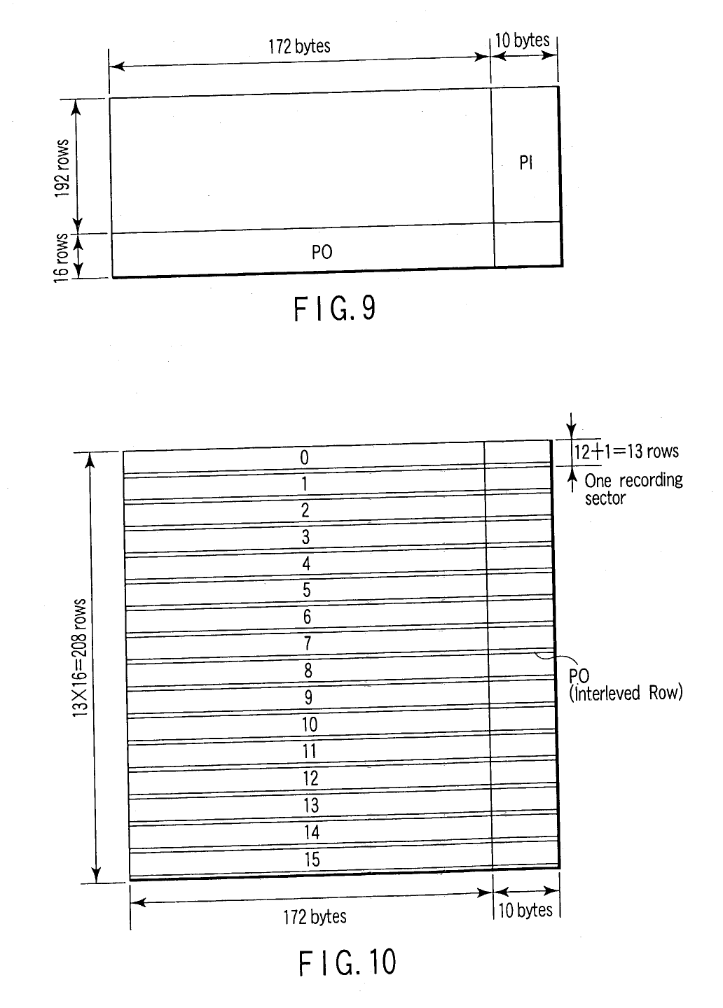

FIG. 9 shows a configuration of an error correction block (ECC block) in accordance with a DVD standard. An error correction internal code PI of 10 bytes (10 columns) is added to each row of 192 rows×172 bytes (172 columns); an error correction external code PO of 16 bytes (16 rows) is added to each row; and an ECC block of 208 (=192+16) rows×182 (=172+10) columns as a whole is configured.

The external code PO of 16 rows (16 bytes) used here is dispersedly allocated (interleaved) for each row (byte) on a 12 rows by 12 rows basis (each sector), as shown in FIG. 10. FIG. 10 shows a state in which 16 sets of recording sectors of 13 (=12+1) rows×182 (=172+10) columns are configured by interleaving. By such dispersive allocation using interleave processing for the external code PO, each sector can take the same format, and a recording system can be easily configured.

FIG. 11 shows an example of configuration of one of the sectors after the external code PO has been interleaved. Hereinafter, this sector is referred to as a recording sector. A part (one row) of the external code PO is added to a sector (12 rows) shown in FIG. 10, and thus, the addition is expressed as 12 rows+1 row.

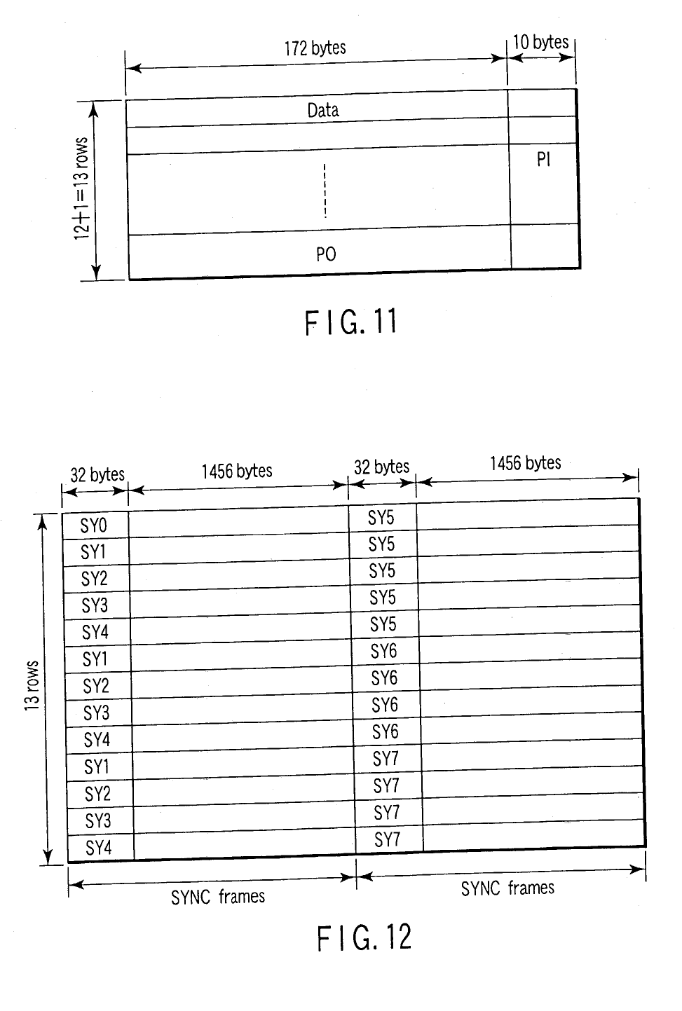

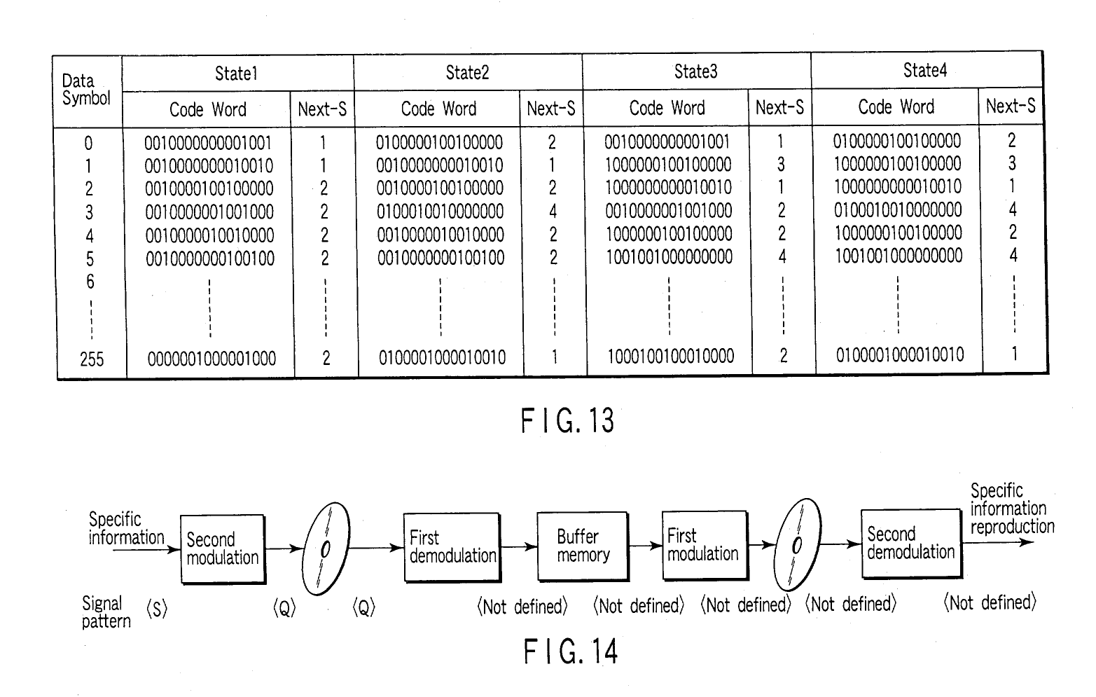

FIG. 12 shows a physical sector in which each symbol is modulated through a modulator when the recording sector of FIG. 11 is recorded, and a synchronization signal is added to obtain a record signal. One row is divided into two frames, and a synchronization signal of 32 channel bits is added to the beginning of each frame. A data symbol is converted through the modulator having a conversion table shown in FIG. 13, and each symbol of 8 bits is converted into 16-channel bits, and one frame comprises a synchronization signal of 32 channel bits and a channel bit signal of 1456 channel bits.

FIG. 13 shows a part of a modulation table used in accordance with the DVD standard. In signal recording or reproduction, the minimum mark length is limited because of a structure and characteristics of a recording medium. In addition, a self clock is used for a recording signal readout clock, thereby making it necessary to impose limitation on the maximum mark length. Because of this, a run length of a record signal is limited. In a DVD, a run length is limited so that main data is within the range of 3 to 11 channel bit lengths.

According to an aspect of the present embodiment, a predetermined part of data to be stored in a recording medium (including a main data portion besides an error correction code) is replaced with specific information that is identification information for detecting illegal copy, or specific information is added to such a part of the data. After changing the predetermined part of data based on the specific information, i.e., by replacing the predetermined part of data with the specific information or adding the specific information to the predetermined part of data, the resultant data is modulated and recorded in a recording medium.

If the predetermined part of data is replaced with the specific information, data is extracted from a predetermined portion before a demodulated signal is processed to be error-corrected, and the extracted data is detected. If the specific information is added to the predetermined part of data, an error pattern detected by error correction processing of main data is obtained as specific information. Thus, the specific information is extracted from data after correction processing, and the extracted specific information is detected.

In order to protect from illegal copy before the error correction processing as shown in FIG. 8 is carried out, in the present embodiment, a modulation pattern, a part of which is not used in a modulation pattern of the main data, is used when specific information is recorded. Thus, during reproduction, if data is passed to a demodulator for the main data, specific information is changed to indefinite data, and illegal copy as shown in FIG. 8 cannot be achieved.

This concept is shown in FIG. 14. Specific information (a signal pattern S) is modulated as a pattern Q by a second modulator, and the modulated pattern Q is recorded in a first recording medium. During reproduction processing, in a first demodulator, the pattern Q is obtained as a pattern which does not exist in a modulation rule, and thus, demodulation data is indefinite. After indefinite data has been fed to a recording drive (has been temporarily stored in a buffer memory), even if the fed data is modulated by the first modulator, and then, modulated data is recorded in a second recording medium, the record pattern recorded in the first recording medium cannot be reproduced.

It is desirable that a modulation pattern used when specific information is recorded should not be used as a modulation pattern used when the main data is recorded and have a pattern for suppressing a direct current component. In accordance with the DVD standard in FIG. 13, in the modulation table, states 1 to 4 are provided in order to make a selection so that the violation of the minimum run length or maximum run length does not occur when a modulated symbol is connected.

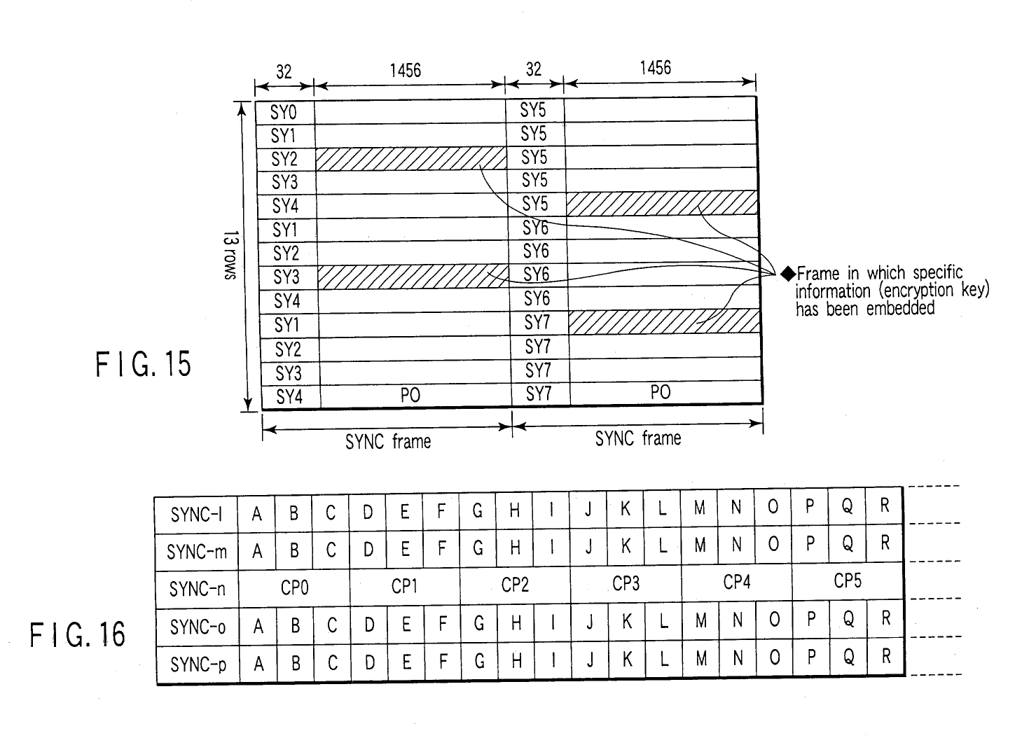

FIG. 15 shows a configuration of a physical sector in which specific information has been embedded according to an aspect of the present embodiment. Specific information may be an encryption key used for encrypting digital data. Specific information is embedded in the case where a place for embedding specific information is predetermined and in the case where such place for embedding the information is not defined and storage place information is inserted into main data.

FIG. 16 is an enlarged view showing a peripheral frame of a physical sector according to an aspect of the present embodiment. Each symbol (8 bits) of the main data is converted into 16 channel bits by a modulator. “A,” “B,” “C,” etc. in FIG. 16 is main data for 16 channel bit data. Specific information CP0, CP1, CP2, . . . does not require division of 16 channel bits, and thus, information on a 48 channel bits by 48 channel bits basis is provided.

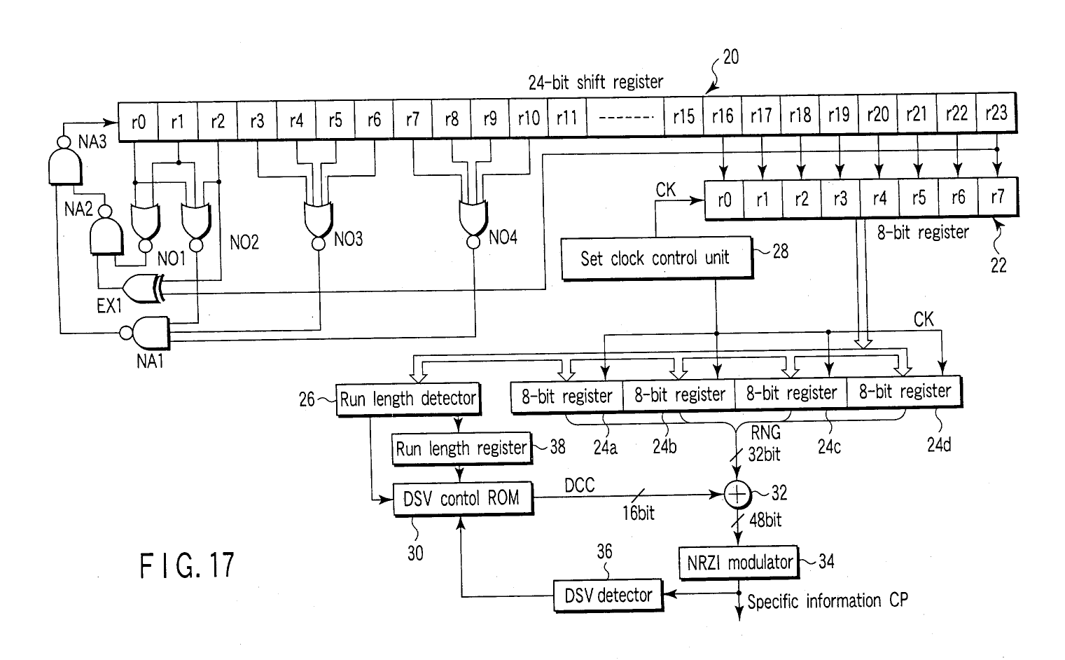

FIG. 17 to FIG. 20 each show a specific example of generating specific information according to an aspect of the present embodiment.

FIG. 17 is a specific block diagram depicting a unit for generating specific information CP0, CP1, CP2, etc. In this generating unit, a run length limiter circuit is added to 24-bit random signal generator (feedback type bit shift register) 20. The random signal generator 20 is obtained as a 24-bit shift register of registers r0 to r23. An output of r0 and an output of r1 are supplied to a NOR gate NO1. An output of r0, an output of r1, and an output of r2 are supplied to a NOR gate NO2. An output of r3, an output of r4, an output of r5, and an output of r6 are supplied to a NOR gate NO3. An output of r7, an output of r8, an output of r9, and an output of r10 are supplied to a NOR gate NO4. An output of r2 and an output of r23 are supplied to an exclusive OR EX1. Outputs of the NOR gate NO1 and exclusive OR EX1 are supplied to a NAND gate NA2. Outputs of NOR gates NO2, NO3, and NO4 are supplied to a NAND gate NA1. Outputs of the NAND gates NA1 and NA2 are supplied to an input of r0 through a NAND gate NA3, and a random generator consisting of a feedback type 24-bit shift register is configured.

After an output of r16 to an output of r23 have been temporarily set in an 8-bit register 22, these outputs are set to four 8-bit registers 24a, 24b, 23c, and 24d; and a run length detector 26. A set clock control unit 28 is connected to the 8-bit registers 22, 24a, 24b, 24c, and 24d. Data contained in the register 22 are sequentially preset in the registers 24a to 24d, and 32-bit random signal data is obtained.

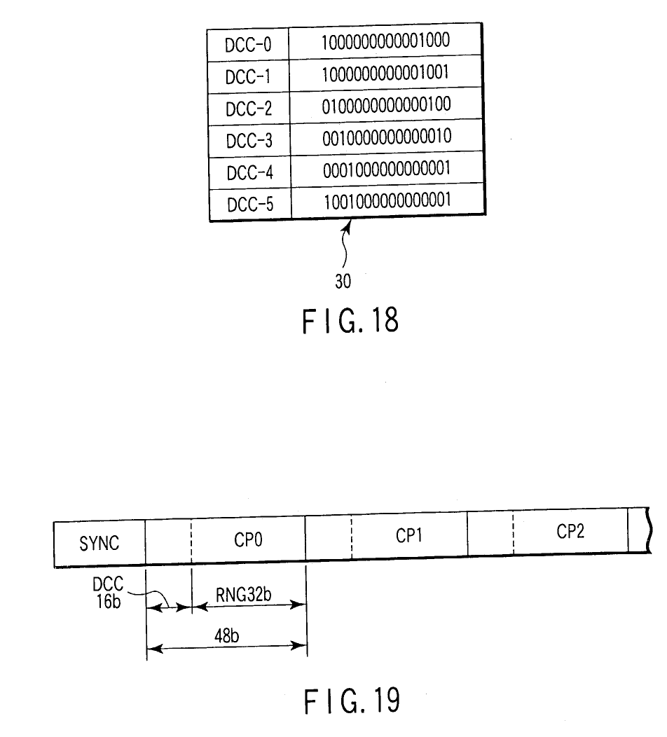

With a synthesizer 32, 16-bit data selectively read out from a DSV control ROM 30 (FIG. 18) is added to this 32-bit random signal data, and a 48-bit specific information (CP) recording signal is generated. This specific information recording signal is modulated by an NRZI modulator 34 (in accordance with a modulation scheme for inverting polarity in location “1” of input data).

As shown in FIG. 18, there are six types of data contained in the DSV control ROM 30. The data selected from among these six types of data is added to 32-bit random signal data by the synthesizer 32. Such a selection is conducted by a DSV detection signal indicating a direct current component detected by plus-counting “1” and minus-counting “0” by a DSV detector 36 with respect to a signal obtained when a specific information recording signal has been NRZI modulated, together with a distance up to “1” existing at the LSB side of 32-bit random signal data detected by the run length detector 26 and set in a run length register 38 and a distance up to “1” existing at the MSB side of specific information recoding signal of a preceding set. Data contained in the DSV control ROM 30 includes run length=12 channel bits, as shown in FIG. 18 (a run length of a record signal of main data is limited by the run length so that the run length is within the range of 3 to 11 channel bit length). By adding this data to 23-bit random signal data, CP0, CP1, CP2, etc. of FIG. 16 passes through a main data demodulator, an indefinite region portion is generated as shown in FIG. 14. Even if illegal copy as shown in FIG. 8 is conducted, a copy product identical to a source specific information signal cannot be made. In a DVD, a synchronization signal uses run length 14 channel bits. Thus, even if the DSV control ROM 30 includes a signal whose run length is 12 channel bits, performance of signal processing on the reproduction apparatus is not affected.

By such an operation, DSV control ROM data is added to random signal data, whereby the following conditions for a specific information recording signal are achieved:

1. “Run length limitation in connection between channel symbol data” or “direct current component suppression” which is similar to that in a main data modulator

2. “Insertion of a modulation pattern which is not used in a main data modulator”

A ROM of (256×16×4)+(88×16×4) bits is used for a DVD main data modulation table (a part of which is shown in FIG. 13). If an attempt is made to configure a specific information modulator which meets the above described two conditions in a way similar to the above, the configuration becomes very complicated. However, a configuration in which a run length limiter circuit is added to a random signal generator as shown in FIG. 17 is facilitated, and the same advantageous effect can be achieved.

FIG. 19 shows a signal allocation example of specific information CP0, CP1, CP2, etc. generated according to FIG. 17.

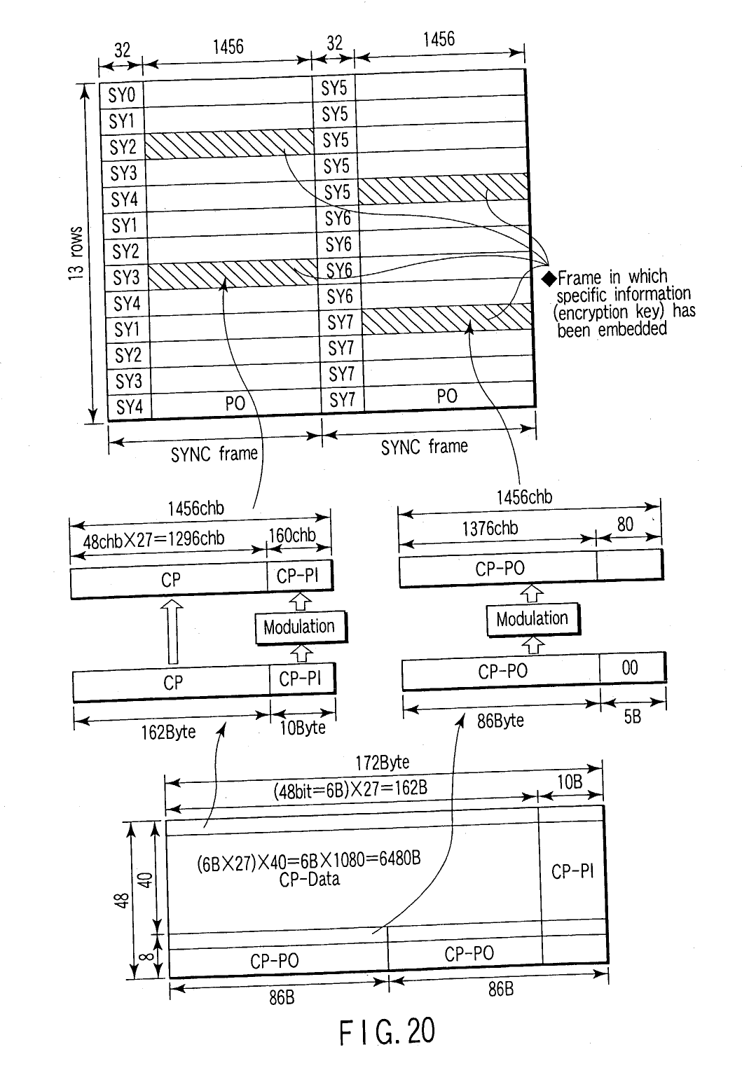

FIG. 20 shows a whole data structure when specific information CP is embedded in a physical sector shown in FIG. 12. Specific information is embedded by replacing a part of main data. This makes it necessary to restore an error such as a defect with specific information itself if such an error occurs. A variety of troubleshooting procedures are taken into consideration. As one method, although it is considered that detection is carried out based on identicalness after multiple recording has been carried out, a method for adding specific information error correction code is generally used.

In the present embodiment, a specific information recording signal is directly generated. It is, however, impossible to use the same method for generating specific information error correction code, and thus, only the error correction code may be modulated and recorded by the use of a main data modulator. There is no need for making specific information error correction code indefinite when demodulated by a main data demodulator, and thus, main data modulation or demodulation processing can be utilized. FIG. 20 shows a relationship between the specific information signal CP and the specific information error correction code CP-PI or CP-PO.

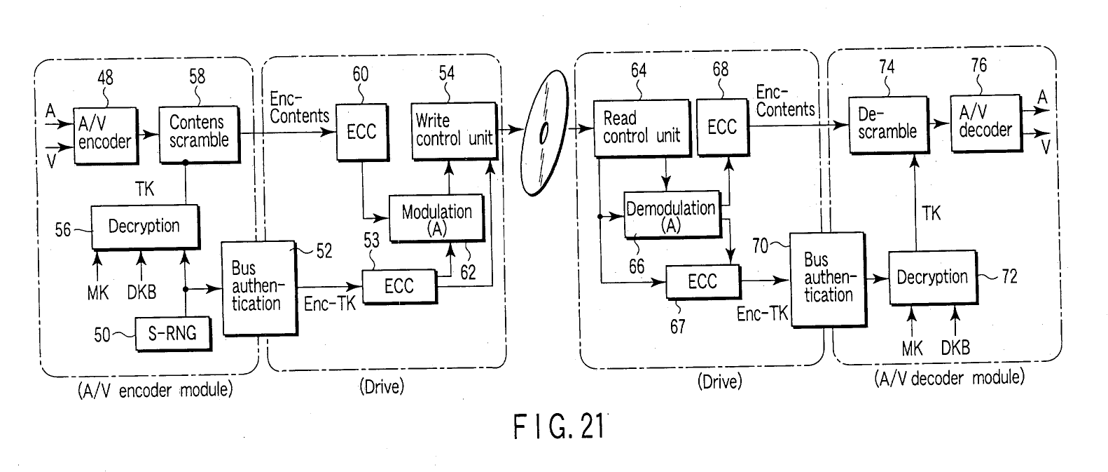

FIG. 21 is a view showing a whole configuration of a recording or reproduction system in which a specific information generating portion of FIG. 17 has been incorporated. A digital signal such as video V or audio A is compressed in accordance with an MPEG scheme or the like by an A/V encoder 48. A specific information recording signal generated by a random signal generator (S-RNG) 50 with a run length limiting function shown in FIG. 17 is fed to the drive apparatus through a bus authenticating unit 52, and then, an error correction code is added by an error correction processing unit (ECC) 53. As shown in FIG. 20, a specific information processing signal is directly supplied to a write control unit 54. In addition, an error correction code for a specific information recording signal is supplied to a modulator 62, the supplied code is modulated, and then, the modulated code is supplied to the write control unit 54.

On the other hand, a specific information recording signal is regarded as an encrypted title key by the use of title key decode processing for contents decryption. Then, a title key TK is obtained (decrypted) by using a master key MK and a disk key set DKB at a decryption unit 56, and the contents output from the A/V encoder 48 are encrypted (scrambled) at a contents scramble unit 58. That is, the specific information signal generated by the random signal generator 50 is regarded as a record signal: Enc-TK of an encrypted title key. To the encrypted contents “Enc-contents” is added an error correction code by an error correction processing unit (ECC) 60, the resultant signal is supplied to a modulator 62, the supplied contents are modulated, and then, the modulated contents are fed to the write control unit 54. The write control unit 54 changes a part of the main data to specific information, as shown in FIG. 15, and writes the information in a recording medium. An NRZI modulator 34 in FIG. 17 is assumed to be incorporated in the write control unit. A modulator 62 in FIG. 21 is entirely described as a processing function for converting symbol data into a channel bit signal.

At the reproduction apparatus, an output of a read control unit 64 is divided into main data and specific information which does not include an error correction code. The specific information is supplied to a specific information error correction processing unit 67. The main data and the specific information error correction code are supplied to a demodulator 66, and the demodulated data is divided into main data and specific information error correction code. The main data is error-corrected by an error correction processing unit 68, and encrypted contents “Enc-contents” are reproduced, and then, are supplied to a de-scramble unit 74. The specific information (encrypted title key Enc-TK) and specific information error correction code are error-corrected by the error correction processing unit 67, and the error-corrected information and code are fed to the decoder module through a bus authenticating unit 70. Then, at a decryption unit 72, a decryption key TK is obtained by the use of a master key MK and a disk key set DKB in the same way as that by the recording apparatus, and the contents are obtained by the use of the processing of FIG. 2.

As has been described above, according to an aspect of the present embodiment, an error correction code is added to a digital signal of a predetermined block and the resultant signal is modulated to be recorded in a recording medium. At the time of recording, a part of the resultant signal is replaced with a random signal whose run length is limited as specific information. Therefore, a modulator for specific information is eliminated.

If a run length of a specific information recording signal is equal to that close to a main data modulation channel bit, it is unnecessary for a reproduction processing system to have special performance.

The run length of the specific information recording signal is set to a run length limit of a modulator for a digital signal of main data plus 1 or minus 1, whereby specific information is made indefinite in a modulator for reproducing a digital signal to which a correction signal has been added, making it easy to protect from illegal copy.

Where an error correction code is added to a specific information signal as well as a digital signal, even when specific information is lost due to a defect or the like, the specific information signal can be correctly detected.

The specific information comprises a plurality of specific information items. If a digital signal comprises a plurality of contents, copyright protection or the like of such contents is processed to be encrypted for each of contents. Specific information utilized for an encryption key or the like is recorded as a group of predetermined units of signal. After a large number of files have been recorded in one recording medium, in the case where an attempt is made to manage illegal copy independently, a large amount of specific information is required. As a result, it is efficient that blocks to which specific information is embedded are grouped, and a plurality of specific information items are grouped, and are embedded in a specific place.

A direct current suppression signal is added to specific information in order to suppress a direct current component during recording.

A specific pattern which is not generated by a main data modulator is added to a random signal generated by a random signal generator, thereby obtaining specific information. Thus, even if specific information before demodulated is demodulated by a main data demodulator during reproduction processing, such demodulation becomes indefinite, thus making it possible to protect from illegal copy on a bit by bit basis.

Protection from illegal copy on a bit by bit basis can be remarkably improved in protection capability by preventing a partial contents encryption key from being output to the outside. Thus, there has been proposed a number of schemes for embedding a signal in a digital signal at a backside in accordance with an electronic watermark processing. For a record signal of a signal to be embedded as well as a record signal of main data, it is required to improve direct current suppression characteristics as in main data modulation processing. This improvement can be achieved with a simple configuration by the addition of a signal having these two functions to a random signal.

Specific information to be recorded can be utilized as an encryption key for contents encryption. In the foregoing description, contents encryption is carried out by an A/V module, and multiple encryption is carried out at the drive in order to improve safeguard property of an encryption key. In the case where a system in which an A/V module or drive is not separated is provided as a simple system, however, such a system is simplified by the use of specific information capable of specifying privacy information for a key for contents encryption.

Specific information is provided as an encrypted contents encryption key, thereby improving capability of protection from illegal copy of a contents encryption key before contents decryption.

In a recording or reproduction drive used for computer environment and a personal computer aided system in which information can be easily edited as well, confidential specific information can be recorded or reproduced in an electronic watermark based method in order to protect from illegal copy or the like of a recording medium having recorded therein information copyright protection. An embedding place may be a data region irrespective of a corrected code region. As a result, copy protection on a bit by bit basis is possible.

Other embodiments of the present invention will be described. The same portions as those of the first embodiment will be indicated in the same reference numerals and their detailed description will be omitted.

Second Embodiment

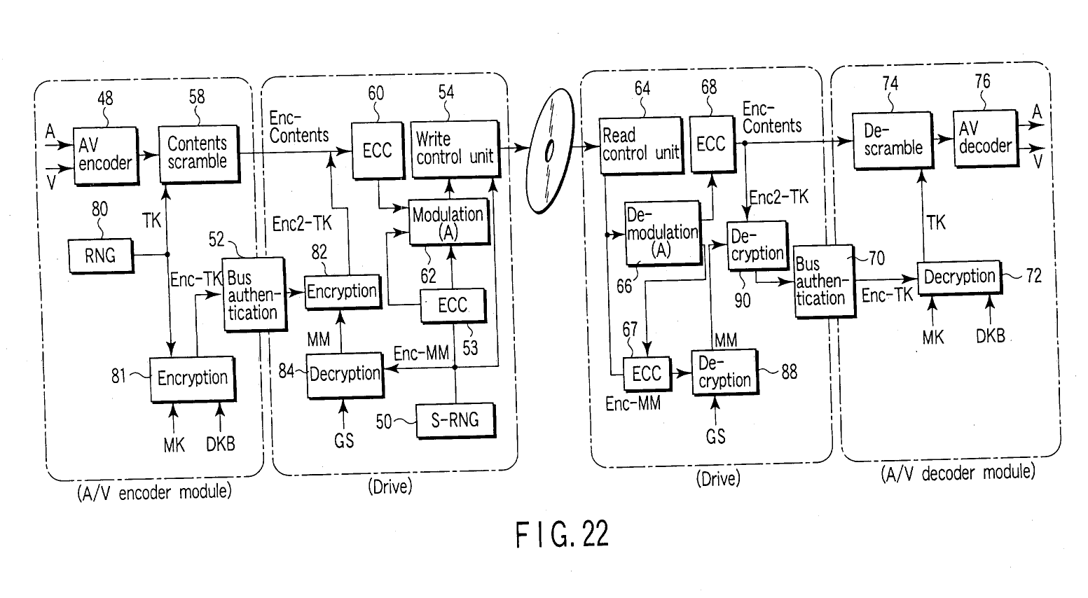

FIG. 22 is a view showing a whole configuration of another recording or reproduction system in which a specific information generating unit of FIG. 17 has been incorporated. An encryption key TK for the contents generated by a random signal generator 80 is used for encrypting contents at a contents scramble unit 58. Further, the encryption key TK is encrypted at an encryption unit 81 by the use of a master key MK or a disk key set DKB. Then, an encrypted encryption key Enc-TK is generated, and is fed to the drive apparatus through a bus authentication circuit 52. At the drive apparatus, a specific information recording signal Enc-MM is generated at a random signal generator (S-RNG) 50 having a run length limiting function. The generated signal is replaced with a part of main data, and is recorded in a disk, as shown in FIG. 15. The specific information recording signal Enc-MM is decoded by a GS signal which is a public key at a decode unit 84, and an MM signal is generated. At an encryption unit 82, an encrypted encryption key Enc-TK is further encrypted, and is recorded as a signal Enc²-TK of the encrypted encryption key or as main data.

At the reproduction apparatus, the specific information signal Enc-MM is decrypted by a public key GS signal at a decryption unit 88 as in the recording apparatus, and the MM signal is generated. The signal Enc²-TK of the encrypted encryption key, which is demodulated from main data and error-corrected, is decrypted at a decryption unit 90 by the MM signal, and a signal Enc-TK of the encrypted encryption key is generated is generated. A signal Enc-TK of the encrypted encryption key is fed to a decoder module through a bus authentication circuit 70, and is decrypted in the same manner as that in the first embodiment shown in FIG. 21. Then, an encryption key TK is obtained, and the encrypted contents are decrypted.

According to the second embodiment, a processing system capable of protection from a bit by bit copy or the like using specific information is carried out in a drive only. Therefore, tampering at the outside, which can occur in a PC system or the like, cannot be carried out, thus making it possible to remarkably improve copyright protection capability.

The present invention is not limited to the above described embodiments, and can be implemented by modifying it variously. For example, in the above description, although specific information is generated by a random signal generator whose run length has been limited, the specific information may be generated by providing this random signal as a run length limiting signal by a code conversion table using a general random signal generator such as an M series signal generator and a modulator used for recording main data, or additionally incorporating in this conversion table a pattern which is not used in a main data modulator.

As has been described above, according to the above embodiments, in the case of encryption an audio/video signal or a digital signal such as personal computer application software, adding an error correction code in units of a predetermined amount of data, and carrying out transmission or recording into a recording medium, confidential specific information is superimposed on main data to configure a data block, and copyright protection is carried out at an initial region for reproduction processing in digital signal reproduction processing, thus making it possible to protect from illegal “batch copy”, which has been conventionally difficult.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. A signal processing apparatus comprising:
a first error correction unit which adds an error correction signal to a digital signal and outputs an error correction block;
a modulation unit which modulates the error correction block;
a random signal generation unit which generates a random signal whose run length is limited;
a changing unit which changes a part of a modulated error correction block output from the modulation unit to the random signal; and
an output unit which outputs an output of the changing unit to at least one of a transmission medium and a recording medium.

2. The signal processing apparatus according to claim 1, wherein the changing unit comprises a replacement unit which replaces the part of the modulated error correction block with the random signal.

3. The signal processing apparatus according to claim 1, wherein
the output unit limits a run length of the output of the changing unit to a predetermined number of bits, and
the random signal generation unit limits a run length of the random signal to the predetermined number of bits.

4. The signal processing apparatus according to claim 1, wherein
the output unit limits a run length of the output of the changing unit to a predetermined number of bits, and
the random signal generation unit limits a run length of the random signal to the predetermined number of bits plus 1 or minus 1.

5. The signal processing apparatus according to claim 1, wherein the error correction signal comprises a product code.

6. The signal processing apparatus according to claim 1, further comprising a second error correction unit which generates an error correction signal of the random signal, and wherein
the error correction signal of the random signal is output to at least one of the transmission medium and the recording medium by the output unit and the random signal is output to at least one of the transmission medium and the recording medium as it is.

7. The signal processing apparatus according to claim 1, wherein the random signal comprises a combination of signal components of N (N being an integer) bits.

8. The signal processing apparatus according to claim 7, further comprising an adder unit which adds a direct current suppression signal to the signal components.

9. The signal processing apparatus according to claim 8, wherein the random signal generation unit generates a random signal of (N-M) bits (M being an integer), adds a predetermined pattern of M bits which is not generated by the output unit to the random signal to generate the signal components of N bits.

10. The signal processing apparatus according to claim 9, wherein the predetermined pattern of M bits comprises a direct current suppression pattern.

11. The signal processing apparatus according to claim 1, wherein the random signal generation unit comprises a generator for generating the random signal and a converter which has a run length limiting function and converts the random signal.

12. A signal processing apparatus comprising:
a random signal generation unit which generates a random signal whose run length is limited;
an encryption unit which encrypts a digital signal using the random signal as a key;
an error correction unit which adds an error correction signal to an encrypted digital signal and outputs an error correction block;
a modulation unit which modulates the error correction block;
a changing unit which changes a part of a modulated error correction block output from the modulation unit to the random signal; and
an output unit which outputs an output of the changing unit to at least one of a transmission medium and a recording medium.

13. A signal processing apparatus comprising:
a random signal generation unit which generates a random signal whose run length is limited;
a first encryption unit which encrypts a digital signal with an encryption key;
a second encryption unit which encrypts the encryption key with an output from the random signal generation unit;
an error correction unit which adds an error correction signal to an encrypted digital signal output from the first encryption unit and an encrypted encryption key from the second encryption unit; and
a changing unit which changes a part of an output from the error correction unit to the random signal; and
an output unit which outputs an output of the changing unit to at least one of a transmission medium and a recording medium.

14. A signal processing apparatus comprising:
a first encryption unit which encrypts a digital signal with a first encryption key;
a second encryption unit which encrypts the first encryption key with a second encryption key;
a random signal generation unit which generates a random signal whose run length is limited;
a decryption unit which decrypts the random signal;
a third encryption unit which encrypts an output from the second encryption unit using an output from the decryption unit as a key;
an error correction unit which adds an error correction signal to an encrypted digital signal output from the first encryption unit and an output from the third encryption unit;
a modulation unit which modulates an output from the error correction unit;
a changing unit which changes a part of an output from the modulation unit to the random signal; and
an output unit which outputs an output of the changing unit to at least one of a transmission medium and a recording medium.
